(19) United States
(12) Patent Application Publication
(10) Pub. No.: US 2025/0010763 A1
(43) Pub. Date: Jan. 9, 2025

(54) CONTROL SYSTEM, WORK VEHICLE MANAGEMENT DEVICE, CONTROL DEVICE, AND METHOD FOR CONTROLLING WORK VEHICLE

(71) Applicant: Komatsu Ltd., Tokyo (JP)

(72) Inventors: Shota Yamawaki, Tokyo (JP); Koji Obata, Tokyo (JP)

(73) Assignee: Komatsu Ltd., Tokyo (JP)

(21) Appl. No.: 18/708,284

(22) PCT Filed: Nov. 14, 2022
(86) PCT No.: PCT/JP2022/042201

§ 371 Date: May 8, 2024

(30) Foreign Application Priority Data
Nov. 15, 2021 (JP) 2021-185952

(51) Int. Cl. B60L 58/40

(52) U.S. Cl. CPC B60L 58/40; B60L 2200/44; B60L 2240/60; B60L 2240/70; B60L 2260/42

(57) ABSTRACT

A route determination unit determines a traveling route of a work vehicle on a work site. An electric power determination unit determines a target electric power generation of a fuel cell during traveling on the traveling route based on topography of the traveling route. The work vehicle controls the fuel cell such that the target electric power generation is output during traveling on the traveling route and controls charging or discharging of a battery based on a difference between required electric power needed for driving the work vehicle and the target electric power generation.

### TECHNICAL FIELD

The present disclosure relates to a control system, a work vehicle management device, a control device, and a method for controlling a work vehicle.

Priority is claimed on Japanese Patent Application No. 2021-185952, filed Nov. 15, 2021, the content of which is incorporated herein by reference.

### BACKGROUND ART

A work vehicle on which a fuel cell using hydrogen gas as a fuel is mounted has been examined. The work vehicle powered by the fuel cell includes, in general, a battery to suppress a mounted amount of the fuel cell and to absorb regenerative electric power when traveling downhill. For this reason, it is necessary for a control device on the work vehicle to perform energy management for appropriately distributing energy of the fuel cell and energy of the battery.

Patent Document 1 discloses a technique of changing an output ratio between a fuel cell and a battery through an adaptive algorithm in a hybrid system using the fuel cell and the battery.

### CITATION LIST

### Patent Document

### Patent Document 1

Specification of Chinese Patent Application, Publication No. 108556672

### SUMMARY OF INVENTION

### Technical Problem

A range extender method is known as a method of operating a power supply system including a fuel cell and a battery. The range extender method is a method in which constant electric power is output from the fuel cell at all times and a difference between electric power required for driving a work vehicle and electric power output by the fuel cell is covered by charging or discharging of the battery. However, the traveling route to a mining site is not necessarily constant, and a load applied to the vehicle while traveling on the traveling route fluctuates. Even in such a case, it is desirable to appropriately acquire electric power output by the fuel cell.

An object of the present disclosure is to provide a control system, a work vehicle management device, a control device, and a method for controlling a work vehicle that can appropriately determine electric power to be output by a fuel cell mounted on a work vehicle.

### Solution to Problem

According to an aspect of the present disclosure, there is provided a control system that controls a work vehicle including a fuel cell and a battery, the system including a route determination unit configured to determine a traveling route of the work vehicle on a work site, an electric power determination unit configured to determine a target electric power generation of the fuel cell during travel on the traveling route based on the topography of the traveling route, a fuel cell control unit configured to control the fuel cell such that the target electric power generation is output during travel on the traveling route, and a battery control unit configured to control charging or discharging of the battery based on a difference between required electric power needed for driving the work vehicle and the target electric power generation during travel on the traveling route.

### Advantageous Effects of Invention

According to the aspect, the control system can appropriately determine electric power to be output by the fuel cell mounted on the work vehicle.

### BRIEF DESCRIPTION OF DRAWINGS

FIG. 1 is a view showing a configuration of a transport system including a management device according to a first embodiment.

FIG. 2 is a perspective view schematically showing a transport vehicle according to the first embodiment.

FIG. 3 is a schematic block diagram showing configurations of a power system and a drive system included in the transport vehicle according to the first embodiment.

FIG. 4 is a schematic block diagram showing a configuration of a control system included in the transport vehicle according to the first embodiment.

FIG. 5 is a schematic block diagram showing a configuration of the management device according to the first embodiment.

FIG. 6 is a flowchart showing setting processing of control data for the management device and the transport vehicle according to the first embodiment.

FIG. 7 is a flowchart showing traveling processing for the transport vehicle according to the first embodiment.

FIG. 8 is a schematic block diagram showing a configuration of a control system included in a transport vehicle according to a second embodiment.

FIG. 9 is a schematic block diagram showing a configuration of a computer according to at least one embodiment.

### DESCRIPTION OF EMBODIMENTS

### First Embodiment

### <<Configuration of Transport System 1>>

Hereinafter, embodiments will be described in detail with reference to the drawings.

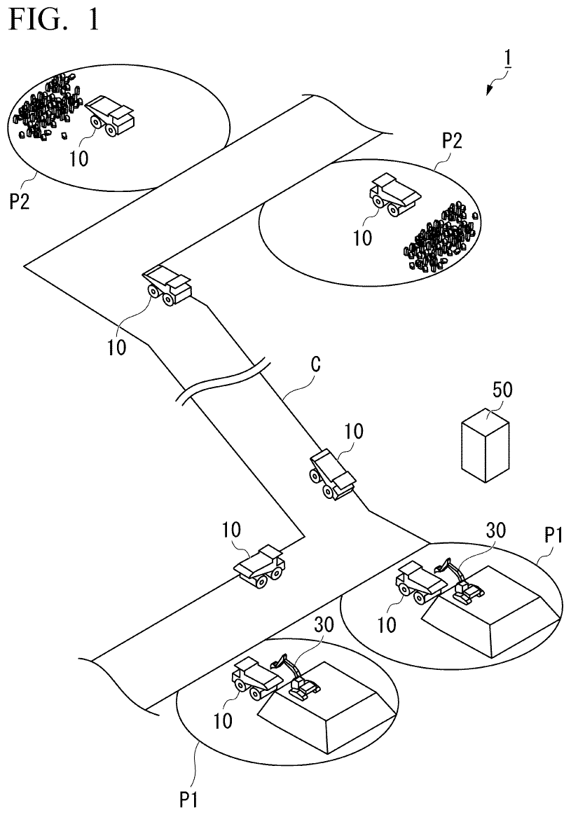

FIG. 1 is a view showing a configuration of a transport system 1 including a management device 50 according to a first embodiment. The transport system 1 is used in order to transport mined crushed stones or the like using a plurality of transport vehicles 10. The transport vehicles 10 are driven by fuel cells fueled by a hydrogen gas. The management device 50 transmits control data to cause the transport vehicles 10 to travel and controls operation of the transport vehicles 10. The transport vehicles 10 are an example of a work vehicle.

In the mine, a mining site P1 and a dumping site P2 are provided. The transport vehicle 10 is loaded with crushed stones by a loading machine 30 at the mining site P1, transports the crushed stones to the dumping site P2, and discharges the crushed stones at the dumping site P2. The loading machine 30 may be, for example, a hydraulic excavator or a wheel loader. When the transport vehicle 10 discharges the crushed stones at the dumping site P2, the transport vehicle 10 moves to the mining site P1 again and loads the mined stones. A course C on which the transport vehicle 10 travels is provided in the mine. The course C may be a two-way road as shown in FIG. 1 or may be a one-way road.

### <<Configuration of Transport Vehicle 10>>

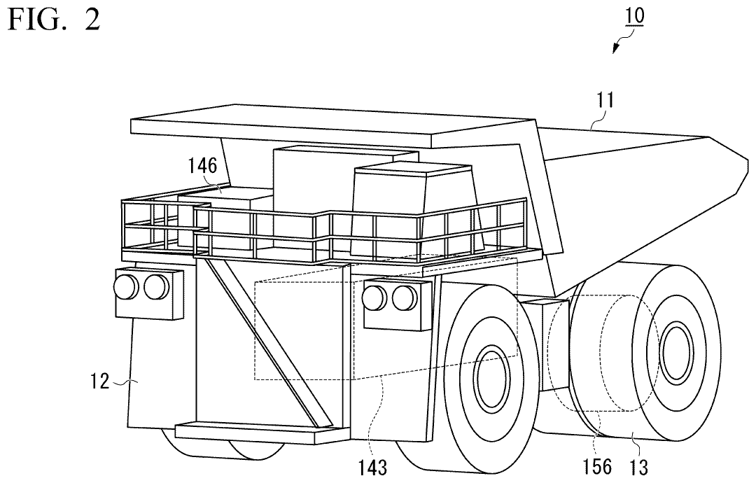

FIG. 2 is a perspective view schematically showing the transport vehicle 10 according to the first embodiment. The transport vehicle 10 includes a dump body 11, a vehicle body 12, and a traveling device 13.

The dump body 11 is a member to be loaded with a load. At least part of the dump body 11 is disposed above the vehicle body 12. The dump body 11 performs a dumping operation and a lowering operation. Through the dumping operation and the lowering operation, the dump body 11 is adjusted to be in a dumping state and a loading state. The dumping state refers to a state in which the dump body 11 is raised. The loading state refers to a state in which the dump body 11 is lowered.

The dumping operation refers to an operation of separating the dump body 11 from the vehicle body 12 and inclining the dump body 11 in a dumping direction. The dumping direction is the rear of the vehicle body 12. In the embodiment, the dumping operation includes raising a front end portion of the dump body 11 and inclining the dump body 11 rearward. Through the dumping operation, a loading surface of the dump body 11 is inclined downward toward the rear.

The lowering operation refers to an operation of bringing the dump body 11 closer to the vehicle body 12. In the embodiment, the lowering operation includes lowering of the front-end portion of the dump body 11.

In a case of carrying out dumping work, the dump body 11 performs the dumping operation to change from the loading state to the dumping state. In a case where the dump body 11 is being loaded with a load, the load is discharged rearward from a rear end portion of the dump body 11 through the dumping operation. In a case of carrying out loading work, the dump body 11 is adjusted to be in the loading state.

The vehicle body 12 includes a vehicle body frame. The vehicle body 12 supports the dump body 11. The vehicle body 12 is supported by the traveling device 13.

The traveling device 13 supports the vehicle body 12. The traveling device 13 causes the transport vehicle 10 to travel. The traveling device 13 causes the transport vehicle 10 to advance or reverse. At least a part of the traveling device 13 is disposed below the vehicle body 12. The traveling device 13 includes a pair of front wheels and a pair of rear wheels. The front wheels are steering wheels, and the rear wheels are driving wheels. A combination of the steering wheels and the driving wheels is not limited thereto, and the traveling device 13 may be four-wheel drive or four-wheel steering.

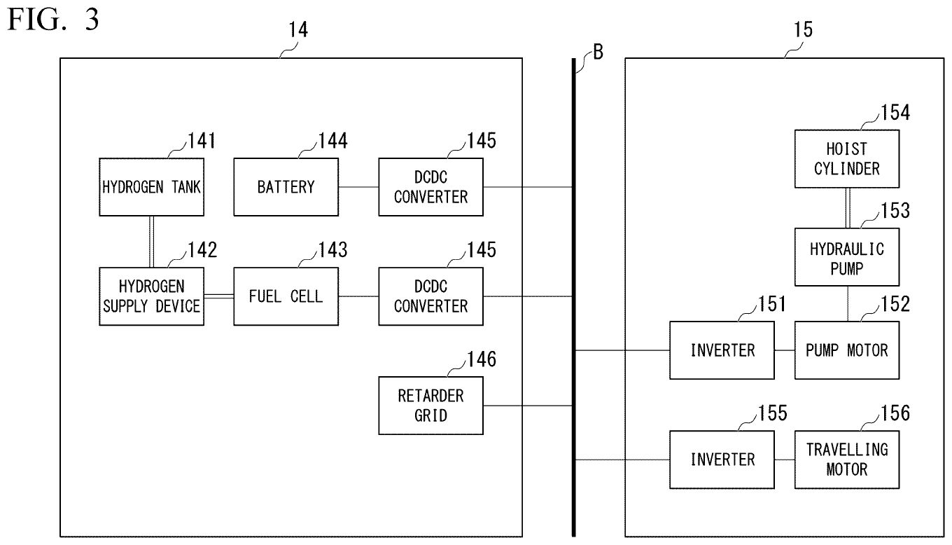

FIG. 3 is a schematic block diagram showing configurations of a power system 14 and a drive system 15 included in the transport vehicle 10 according to the first embodiment. The power system 14 includes a hydrogen tank 141, a hydrogen supply device 142, a fuel cell 143, a battery 144, a DCDC converter 145, and a retarder grid 146.

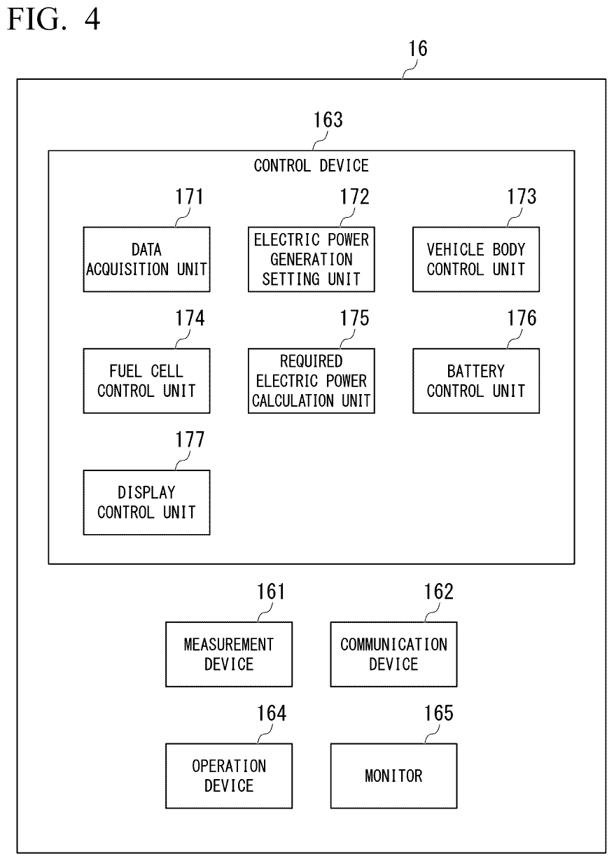

The hydrogen supply device 142 supplies hydrogen gas filling the hydrogen tank 141 to the fuel cell 143. The fuel cell 143 generates electric power by causing an electrochemical reaction between the hydrogen supplied from the hydrogen supply device 142 and oxygen included in outside air. The battery 144 stores the electric power generated by the fuel cell 143. The DCDC converter 145 causes the electric power output from the connected fuel cell 143 or the connected battery 144 according to an instruction from a control system 16 (see FIG. 4). The retarder grid 146 converts regenerative electric power from the drive system 15 into heat energy in a case where the battery 144 cannot be charged.

Electric power output by the power system 14 is output to the drive system 15 via a bus B. The drive system 15 has an inverter 151, a pump drive motor 152, a hydraulic pump 153, a hoist cylinder 154, an inverter 155, and a travelling drive motor 156. The inverter 151 converts a direct current from the bus B into a three-phase alternating current and supplies the three-phase alternating current to the pump drive motor 152. The pump drive motor 152 drives the hydraulic pump 153. A hydraulic oil discharged from the hydraulic pump 153 is supplied to the hoist cylinder 154 via a control valve (not shown). As the hydraulic oil is supplied to the hoist cylinder 154, the hoist cylinder 154 operates. The hoist cylinder 154 causes the dump body 11 to perform the dumping operation or the lowering operation. The inverter 155 converts a direct current from the bus B into a three-phase alternating current and supplies the three-phase alternating current to the travelling drive motor 156. A rotational force generated by the travelling drive motor 156 is transmitted to the driving wheels of the traveling device 13.

The transport vehicle 10 includes the control system 16 that controls the power system 14 and the drive system 15. FIG. 4 is a schematic block diagram showing a configuration of the control system 16 included in the transport vehicle 10 according to the first embodiment. The control system 16 includes a measurement device 161, a communication device 162, and a control device 163, an operation device 164, and a monitor 165.

The measurement device 161 collects data related to an operating state and a traveling state of the transport vehicle 10. The measurement device 161 includes at least a positioning device that measures a position and an azimuth direction of the transport vehicle 10 with a global navigation satellite system (GNSS), a speed meter that measures the speed of the transport vehicle 10, and a remaining amount meter that measures a charging rate of the battery 144.

The communication device 162 communicates with the management device 50 via a mobile communication network or the like. The communication device 162 transmits measurement data storing various types of measured values measured by the measurement device 161 to the management device 50. The communication device 162 receives control data for controlling the transport vehicle 10 from the management device

The control device 163 drives the transport vehicle 10 according to control data and an operation amount of the operation device 164 received by the communication device 162 from the management device 50.

The operation device 164 is provided in an operator cab and receives an operation by an operator. The operation device 164 includes an accelerator pedal, a brake pedal, a steering wheel, a dump lever, and the like.

The monitor 165 is provided in the operator cab and displays a traveling route or the like to the operator.

The control device 163 includes a data acquisition unit 171, an electric power generation setting unit 172, a vehicle body control unit 173, a fuel cell control unit 174, a required electric power calculation unit 175, a battery control unit 176, and a display control unit 177.

The data acquisition unit 171 acquires control data from the communication device 162 and acquires measurement data from the measurement device 161.

The electric power generation setting unit 172 determines a target electric power generation that is a target value of electric power output by the fuel cell 143 based on the control data acquired by the data acquisition unit 171. The electric power generation setting unit 172 sets the determined target electric power generation in the fuel cell control unit 174. The electric power generation setting unit 172 is an example of an electric power determination unit that determines a target electric power generation. The electric power generation setting unit 172 according to the first embodiment sets a unique target electric power generation for each traveling route. That is, the target electric power generation is a constant value during traveling on the traveling route.

The vehicle body control unit 173 generates a control signal for controlling the transport vehicle 10 by an operation amount of the operation device 164. For example, the vehicle body control unit 173 generates a control signal for controlling steering, accelerating, braking, a dump body operation, and the like of the traveling device 13.

The fuel cell control unit 174 controls a hydrogen supply amount for the hydrogen supply device 142 such that the fuel cell 143 outputs the target electric power generation set by the electric power generation setting unit 172. In the first embodiment, since a constant value is set as a target electric power generation regardless of a time, the fuel cell control unit 174 controls the hydrogen supply amount for the hydrogen supply device 142 such that constant electric power is output during traveling on the traveling route.

The required electric power calculation unit 175 calculates required electric power, which is required for the power system 14, based on a control signal generated by the vehicle body control unit 173.

The battery control unit 176 calculates a difference between generated electric power of the fuel cell 143 and required electric power. The battery control unit 176 causes the battery 144 to be charged with electric power related to the difference in a case where generated electric power is larger than the required electric power and controls the DCDC converter 145 connected to the battery 144 such that the electric power related to the difference is discharged from the battery 144 in a case where the generated electric power is smaller than the required electric power.

The display control unit 177 causes the monitor 165 to display a traveling route included in control data.

### <<Configuration of Management Device 50>>

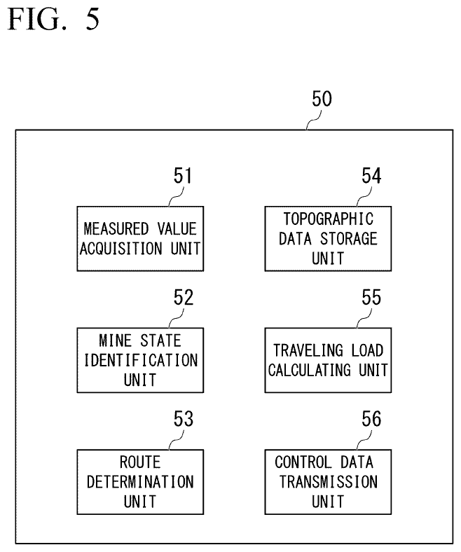

FIG. 5 is a schematic block diagram showing a configuration of the management device 50 according to the first embodiment.

The management device 50 includes a measured value acquisition unit 51, a mine state identification unit 52, a route determination unit 53, a topographic data storage unit 54, a traveling load calculating unit 55, and a control data transmission unit 56.

The measured value acquisition unit 51 receives a position, an azimuth direction, and a speed from the plurality of transport vehicles 10.

The mine state identification unit 52 identifies congestion states of the mining site P1 and the dumping site P2 based on a measured value acquired by the measured value acquisition unit 51. For example, the mine state identification unit 52 identifies the number or the like of transport vehicles 10 that stand by on the mining site P1 and the dumping site P2.

The route determination unit 53 determines a traveling route on which the transport vehicle 10, which has completed loading work on the mining site P1, moves from the mining site P1 to the next mining site P1 via the dumping site P2 based on the state identified by the mine state identification unit 52. For example, the route determination unit 53 can assign a traveling route, on which the transport vehicle 10 passes the mining site P1 where the number of the transport vehicle 10 standing by is relatively small and the dumping site P2, to the transport vehicle 10. The mining site P1 at a starting point of the traveling route and the mining site P1 at an end point may be the same or may be different from each other. The management device 50 can recognize completion of the loading work, for example, by receiving a signal indicating loading completion from the loading machine 30 to the transport vehicle 10. In addition, the management device 50 can recognize the completion of the loading work, for example, as a loaded weight of the dump body 11 of the transport vehicle 10 positioned on the mining site P1 exceeds a predetermined value and a traveling speed is a predetermined value or more.

The topographic data storage unit 54 stores topographic data of the mine. Specifically, the topographic data stores a gradient or the like for each position of the course C.

The traveling load calculating unit 55 calculates a traveling load and a required time, which are needed for traveling on the traveling route, based on a traveling route determined by the route determination unit 53 and the topographic data stored by the topographic data storage unit 54. The traveling load calculating unit 55 calculates a standby time on the mining site P1, a load caused by operation of the dump body 11 on the dumping site P2, and a traveling load and a required time in consideration of regenerative electric power when traveling downhill.

The control data transmission unit 56 transmits control data indicating the traveling route determined by the route determination unit 53 and the traveling load and the required time, which are calculated by the traveling load calculating unit 55, to the transport vehicle 10.

### <<Operation of Management Device 50>>

The measured value acquisition unit 51 of the management device 50 receives measurement information at any time from the transport vehicle 10, and the mine state identification unit 52 updates states of the mining site P1 and the dumping site P2.

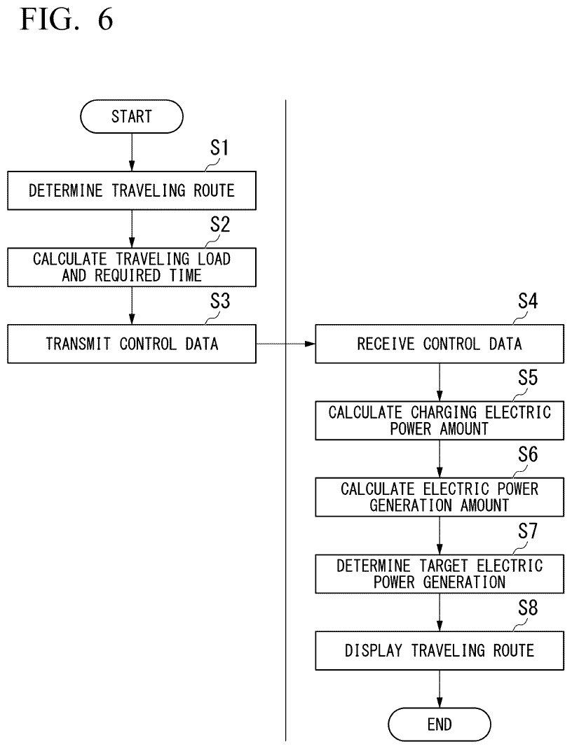

FIG. 6 is a flowchart showing setting processing of control data for the management device 50 and the transport vehicle 10 according to the first embodiment. When the management device 50 detects that loading work of the transport vehicle 10 is completed, the management device 50 and the transport vehicle 10 execute setting processing of control data shown in FIG. 6.

The route determination unit 53 determines a traveling route to be moved from the mining site P1 to the next mining site P1 via the dumping site P2 based on states of the mining site P1 and the dumping site P2 which are identified by the mine state identification unit 52 (Step S1). Next, the traveling load calculating unit 55 calculates a traveling load and a required time, which are needed for traveling on the traveling route, based on the traveling route determined in Step S1 and topographic data stored by the topographic data storage unit 54 (Step S2). The control data transmission unit 56 transmits control data indicating the traveling route determined in Step S1 and the traveling load and the required time, which are calculated in Step S2, to the transport vehicle 10 (Step S3).

The data acquisition unit 171 of the transport vehicle 10 receives the control data from the management device 50 via the communication device 162 (Step S4). The electric power generation setting unit 172 acquires a charging electric power amount to be supplied to the battery 144 during traveling by multiplying a difference between a charging rate of the battery 144 and a target charging rate at the end point of the traveling route determined in advance by the rated capacity of the battery 144 (Step S5). In a case where the charging rate of the battery 144 is larger than the target charging rate, a value of the charging electric power amount is a negative number, representing that an electric power amount, which is an absolute value thereof, is to be discharged. The target charging rate may be the same value as the current charging rate. Next, the electric power generation setting unit 172 calculates a required electric power generation amount during traveling on the traveling route by adding the charging electric power amount to the traveling load included in the control data received in Step S4 (Step S6). Next, the electric power generation setting unit 172 determines a value obtained by dividing the electric power generation amount calculated in Step S6 by the required time included in the control data as a target electric power generation output by the fuel cell 143 during traveling (Step S7). The electric power generation setting unit 172 sets the determined target electric power generation in the fuel cell control unit 174. Then, the display control unit 177 generates a display signal for displaying the traveling route included in the control data on the monitor 165 and outputs the display signal to the monitor 165 (Step S8).

Accordingly, the operator can recognize the traveling route by viewing the monitor 165 and starts traveling along the traveling route.

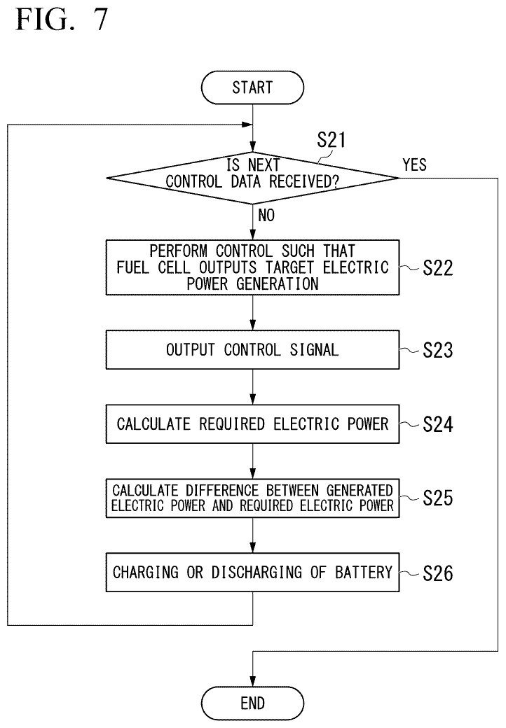

FIG. 7 is a flowchart showing traveling processing for the transport vehicle 10 according to the first embodiment.

The control device 163 determines whether or not the next control data is received from the management device 50 (Step S21). In a case where the next control data is not received from the management device 50 (Step S21: NO), processing of Steps S22 to S26 shown below is repeatedly executed. The next control data is received when traveling on the traveling route is finished and loading of crushed stones is completed.

The fuel cell control unit 174 controls the hydrogen supply device 142 such that the fuel cell 143 outputs the target electric power generation calculated in Step S7 (Step S22). Since the target electric power generation is calculated in Step S7 and is not updated until the next control data is received, the fuel cell 143 generates constant electric power during traveling on the traveling route. The vehicle body control unit 173 generates a control signal for controlling the transport vehicle 10 based on an operation amount of the operation device 164 and outputs the control signal to each actuator (Step S23). The required electric power calculation unit 175 calculates required electric power needed for the power system 14 based on the control signal generated in Step S23 (Step S24). The battery control unit 176 calculates a difference between generated electric power of the fuel cell 143 and the required electric power (Step S25). The battery control unit 176 controls the DCDC converter 145 connected to the battery 144 such that the battery 144 is charged or discharged based on electric power related to the difference (Step S26). Then, the control device 163 returns processing to Step S21 and determines reception of the next control data.

When the control device 163 receives the next control data from the management device 50 (Step S21: YES), the control device 163 ends the traveling processing and starts traveling processing based on the next control data.

### <<Workings and Effects>>

As described above, the transport system 1 according to the first embodiment determines a target electric power generation of the fuel cell 143 during traveling on a traveling route based on topography of the traveling route and controls the fuel cell 143 according thereto. Accordingly, as the transport vehicle 10 travels along the determined traveling route, and load fluctuations are absorbed by the battery 144, the charging rate of the battery 144 after traveling on the traveling route can be a desired charging rate.

The traveling route of the first embodiment has the mining site P1 as the starting point, the dumping site P2 as a relay, and the next mining site P1 as the end point. In general, since a traveling route between the mining site P1 and the dumping site P2 is a slope, regenerative electric power when traveling downhill can be consumed when climbing a hill by optimizing a target electric power generation in the traveling route returning to the mining site P1 via the dumping site P2. In the other embodiment, the traveling route may have the dumping site P2 as a starting point, the mining site P1 as a relay, and the next dumping site P2 as an end point. In this case, the management device 50 starts setting processing of control data, for example, when the transport vehicle 10 has performed dumping operation and lowering operation of the dump body 11.

### Second Embodiment

The transport vehicle 10 according to the first embodiment controls the fuel cell 143 according to control data received from the management device 50. On the other hand, the transport vehicle 10 according to a second embodiment controls the fuel cell 143 based on basic electric power generation determined in advance and control data.

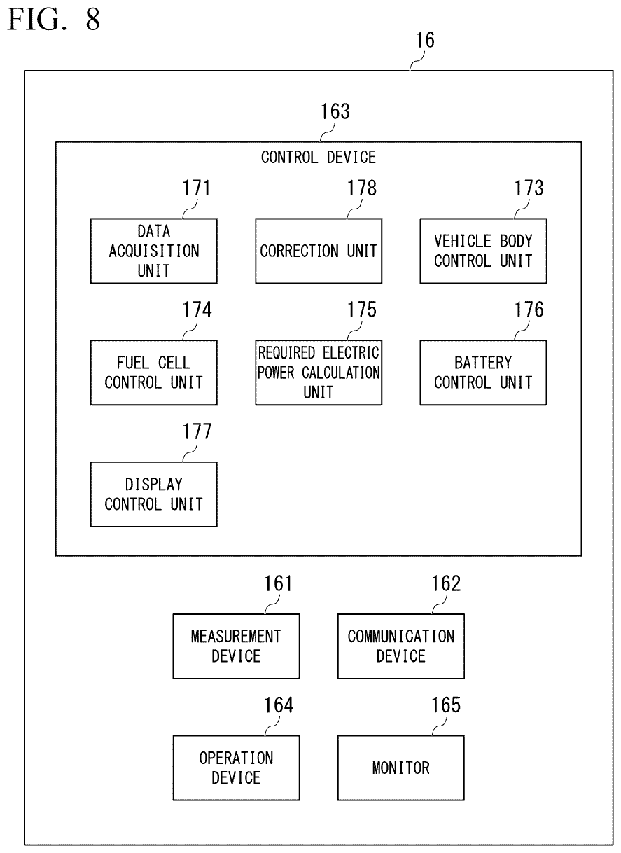

FIG. 8 is a schematic block diagram showing a configuration of the control system 16 included in the transport vehicle 10 according to the second embodiment. The control device 163 of the transport vehicle 10 according to the second embodiment includes a correction unit 178 instead of the electric power generation setting unit 172 in the configuration of the first embodiment.

The fuel cell control unit 174 according to the second embodiment generates a control signal of the hydrogen supply device 142 such that the fuel cell 143 outputs basic electric power generation.

In addition, the battery control unit 176 according to the second embodiment generates a control signal of the DCDC converter 145 connected to the battery 144 based on a difference between the basic electric power generation of the fuel cell 143 and required electric power.

The correction unit 178 calculates a target electric power generation output by the fuel cell 143 based on control data acquired by the data acquisition unit 171 and calculates a difference between the target electric power generation and basic electric power generation of the fuel cell 143. The correction unit 178 corrects a control signal of the hydrogen supply device 142 generated by the fuel cell control unit 174 and a control signal of the DCDC converter 145 generated by the battery control unit 176 based on the calculated difference. That is, the correction unit 178 performs correction of adding a control amount corresponding to the calculated difference to a control amount indicated by the control signal of the hydrogen supply device 142 and performs correction of subtracting the control amount corresponding to the calculated difference from the control amount indicated by the control signal of the DCDC converter 145.

The correction unit 178 does not perform correction of a control signal in a case where the data acquisition unit 171 cannot acquire control data or a case where a target electric power generation is not included in control data. Accordingly, the transport vehicle 10 according to the second embodiment can operate the fuel cell 143 with basic electric power generation even in a case where the control data cannot be acquired.

### Other Embodiment

Although one embodiment has been described in detail with reference to the drawings hereinbefore, a specific configuration is not limited to the description above, and various design changes are possible. That is, in the other embodiment, order of processing described above may be changed as appropriate. In addition, some of the processing may be performed in parallel.

The management device 50 and the control device 163 according to the embodiments described above may be configured by a single computer, or the configuration of the management device 50 or the control device 163 may be divided and disposed into a plurality of computers, so that the plurality of computers cooperates with each other to function as the management device 50 or the control device 163. At this time, some computers configuring the control device 163 may be mounted inside the transport vehicle 10, and the other computers may be provided outside the transport vehicle 10.

The transport vehicle 10 according to the embodiments described above is a manned vehicle operated by the operator but is not limited thereto. For example, the transport vehicle 10 according to the other embodiment may be an unmanned vehicle that automatically travels. In this case, the control system 16 of the transport vehicle 10 may not include the operation device 164 and the monitor 165. In addition, the vehicle body control unit 173 may generate a control signal through PID control or the like using a traveling route and a measured value of the measurement device 161.

In addition, the transport vehicle 10 has been described as an example of the work vehicle in the embodiments described above but is not limited thereto. For example, in the other embodiment, the management device 50 may manage other work vehicles such as a hydraulic excavator, a wheel loader, and a dump truck.

In addition, the transport vehicle 10 is driven in a range extender method in which constant electric power is output from the fuel cell 143 at all times, and a difference between electric power required for driving the transport vehicle 10 and electric power output by the fuel cell 143 is covered by charging or discharging of the battery 144 in the embodiment described above but is not limited thereto. For example, in the other embodiment, the transport vehicle 10 may be driven in a prime mover method in which electric power output from the fuel cell 143 fluctuates according to a load of the transport vehicle 10. In this case, the electric power generation setting unit 172 determines a target electric power generation such that electric power output by the fuel cell 143 during traveling on the traveling route fluctuates in a range narrower than a fluctuation range of required electric power needed for driving the transport vehicle 10. For example, the electric power generation setting unit 172 may set, as a target electric power generation, electric power which is less than the required electric power in a case where electric power to be output by the fuel cell 143 is set for each of steering, accelerating, braking, and a dump body operation. In addition, for example, the electric power generation setting unit 172 may set a value less than 100% as a ratio of a target electric power generation with respect to required electric power. In addition, for example, the electric power generation setting unit 172 may set a time series of the target electric power generation.

### <Computer Configuration>

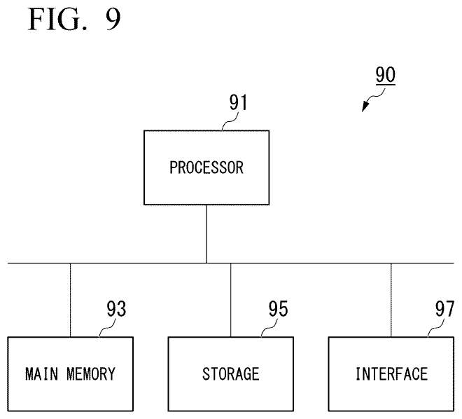

FIG. 9 is a schematic block diagram showing a configuration of a computer according to at least one embodiment.

A computer 90 includes a processor 91, a main memory 93, a storage 95, and an interface 97.

Each of the management device 50 and the control device 163 described above is mounted on the computer 90. In addition, an operation of each processing unit described above is stored in the storage 95 in a form of a program. The processor 91 reads out the program from the storage 95, develops the program on the main memory 93, and executes the processing according to the program. In addition, the processor 91 secures a storage region corresponding to each storage unit described above in the main memory 93 according to the program. Examples of the processor 91 include a central processing unit (CPU), a graphic processing unit (GPU), and a microprocessor.

The program may be used to implement some of the functions of the computer 90. For example, the program may implement the functions in combination with other programs already stored in the storage or in combination with other programs installed in other devices. In the other embodiment, the computer 90 may include a custom large scale Integrated circuit (LSI) such as a programmable logic device (PLD) in addition to the configuration or instead of the configuration. Examples of the PLD include a programmable array logic (PAL), a generic array logic (GAL), a complex programmable logic device (CPLD), and a field programmable gate array (FPGA). In this case, some or all of the functions realized by the processor 91 may be realized by the integrated circuit. Such an integrated circuit is also included as an example of the processor.

Examples of the storage 95 include a magnetic disk, a magneto-optical disk, an optical disk, and a semiconductor memory. The storage 95 may be an internal medium that is directly connected to a bus of the computer 90 or may be an external medium that is connected to the computer 90 via the interface 97 or a communication line. In addition, in a case where the program is distributed to the computer 90 via the communication line, the computer 90 that has received the distribution may develop the program on the main memory 93 and execute the processing. In at least one embodiment, the storage 95 is a non-transitory tangible storage medium.

In addition, the program may be for realizing some of the functions described above. Further, the program may be a so-called differential file (differential program) that realizes the functions described above in combination with other programs already stored in the storage 95.

### INDUSTRIAL APPLICABILITY

The control system can appropriately determine electric power to be output by the fuel cell mounted on the work vehicle.

### REFERENCE SIGNS LIST

1: Transport system
10: Transport vehicle
11: Dump body
12: Vehicle body
13: Traveling device
14: Power system
141: Hydrogen tank
142: Hydrogen supply device
143: Fuel cell
144: Battery
145: DCDC converter
146: Retarder grid
15: Drive system
151: Inverter
152: Pump drive motor
153: Hydraulic pump
154: Hoist cylinder
155: Inverter
156: Travelling drive motor
16: Control system
161: Measurement device
162: Communication device
163: Control device
164: Operation device
165: Monitor
171: Data acquisition unit
172: Electric power generation setting unit
173: Vehicle body control unit
174: Fuel cell control unit
175: Required electric power calculation unit
176: Battery control unit
177: Display control unit
178: Correction unit
30: Loading machine
50: Management device
51: Measured value acquisition unit
52: Mine state identification unit
53: Route determination unit
54: Topographic data storage unit
55: Traveling load calculating unit
56: Control data transmission unit
90: Computer
91: Processor
93: Main memory
95: Storage
97: Interface
C: Course
P1: Mining site
P2: Dumping site

1. A control system that controls a work vehicle including a fuel cell and a battery, the system comprising:
a route determination unit configured to determine a traveling route of the work vehicle on a work site;
an electric power determination unit configured to determine a target electric power generation of the fuel cell during traveling on the traveling route based on topography of the traveling route;
a fuel cell control unit configured to control the fuel cell such that the target electric power generation is output during traveling on the traveling route; and
a battery control unit configured to control charging or discharging of the battery based on a difference between required electric power needed for driving the work vehicle and the target electric power generation during traveling on the traveling route.

2. The control system according to claim 1,
wherein the electric power determination unit determines the target electric power generation such that a fluctuation range of the target electric power generation is smaller than a fluctuation range of the required electric power during traveling on the traveling route.

3. The control system according to claim 1,
wherein the electric power determination unit determines the target electric power generation which is constant during traveling on the traveling route.

4. The control system according to claim 1,
wherein the electric power determination unit determines the target electric power generation such that a charging amount of the battery at an end point of the traveling route is a predetermined target charging amount.

5. The control system according to claim 1,
wherein the route determination unit determines the traveling route having a mining site as a starting point, having a dumping site as a relay, and having a next mining site as an end point or the traveling route having the dumping site as a starting point, having the mining site as a relay, and having the next dumping site as an end point.

6. The control system according to claim 1, further comprising:
a correction unit configured to acquire corrected electric power that is a difference between basic electric power generation determined in advance and the target electric power generation,
wherein the fuel cell control unit controls the fuel cell based on the basic electric power generation and the corrected electric power, and
the battery control unit controls charging or discharging of the battery based on the required electric power, the basic electric power generation, and the corrected electric power.

7. A work vehicle management device that manages a work vehicle including a fuel cell and a battery, the device comprising:
a route determination unit configured to determine a traveling route of the work vehicle on a work site;
a load calculating unit configured to calculate a magnitude of a load applied to the vehicle while traveling on the traveling route based on topography of the traveling route; and
a transmission unit configured to transmit, to the work vehicle, control data including data related to the traveling route and the magnitude of the load.

8. A control device of a work vehicle including a fuel cell and a battery, the device comprising:
a reception unit configured to receive the control data from the management device according to claim 7;
an electric power determination unit configured to determine a target electric power generation of the fuel cell during traveling on the traveling route based on the magnitude of the load included in the control data;
a fuel cell control unit configured to control the fuel cell such that the target electric power generation is output during traveling on the traveling route; and
a battery control unit configured to control charging or discharging of the battery based on a difference between required electric power needed for driving the work vehicle and the target electric power generation during traveling on the traveling route.

9. The control device according to claim 8,
wherein the electric power determination unit determines the target electric power generation such that a fluctuation range of the target electric power generation is smaller than a fluctuation range of the required electric power during traveling on the traveling route.

10. The control device according to claim 8,
wherein the electric power determination unit determines the target electric power generation which is constant during traveling on the traveling route.

11. A method for controlling a work vehicle including a fuel cell and a battery, the method comprising:
a step of determining a traveling route of the work vehicle on a work site;
a step of determining a target electric power generation of the fuel cell during traveling on the traveling route based on topography of the traveling route;
a step of generating a control signal of the work vehicle according to the traveling route;
a step of controlling the fuel cell such that the target electric power generation is output during traveling on the traveling route; and
a step of controlling charging or discharging of the battery based on a difference between required electric power for control according to the control signal and the target electric power generation during traveling on the traveling route.

12. The method for controlling a work vehicle according to claim 11,
wherein in the step of determining the target electric power generation, the target electric power generation is determined such that a fluctuation range of the target electric power generation is smaller than a fluctuation range of the required electric power during traveling on the traveling route.

13. The method for controlling a work vehicle according to claim 11,
wherein in the step of determining the target electric power generation, the target electric power generation which is constant during traveling on the traveling route is determined.
